(19) United States
(12) Patent Application Publication
(10) Pub. No.: US 2017/0120500 A1
(43) Pub. Date: May 4, 2017

(54) EXTRUDER FOR USE IN AN ADDITIVE MANUFACTURING PROCESS

(71) Applicant: TYCO ELECTRONICS CORPORATION, Berwyn, PA (US)

(72) Inventor: Gaurang N. NAWARE, Harrisburg, PA (US)

(21) Appl. No.: 14/932,044

(22) Filed: Nov. 4, 2015

(51) Int. Cl. B29C 47/86; B29C 67/00; B29C 47/10; B29C 47/12; B29C 47/92

(52) U.S. Cl. CPC B29C 47/862; B29C 47/122; B29C 47/92; B29C 47/10; B29C 67/0055; B29C 67/0085; B33Y 30/00

(57) ABSTRACT

An extruder for use in an additive manufacturing process. The extruder includes an inner housing and an outer housing. A material feed channel extends through the extruder. The material feed channel is positioned between the inner housing and the outer housing. The inner housing is mounted to allow the inner housing to rotate relative to the outer housing, and the outer housing is mounted to allow the outer housing to rotate relative to the inner housing. The rotation of the inner housing and outer housing moves material through the material feed channel and introduces shear forces to the material to decrease the viscosity of the material. A heating element is provided proximate the housing and extends about the entire circumference of the housing. The heating element provides even and controlled heating across the entire extruder.

### FIELD OF THE INVENTION

The present invention is directed to an extruder which is heated and can be used for additive manufacturing. In particular, the invention is directed to a heated extruder which introduces shear to the material to better control the viscosity of the material.

### BACKGROUND OF THE INVENTION

Additive manufacturing systems are used to print or otherwise build three-dimensional parts from digital representations of the three-dimensional parts using one or more additive manufacturing techniques. Examples of commercially available additive manufacturing techniques include extrusion-based techniques, jetting, selective laser sintering, powder/binder jetting, electron-beam melting and stereo lithographic processes. For each of these techniques, the digital representation of the three-dimensional part is initially sliced into multiple horizontal layers. For each sliced layer, one or more tool paths are then generated, which provides instructions for the particular additive manufacturing system to print the given layer.

For example, in an extrusion-based additive manufacturing system, a three-dimensional part may be printed from a digital representation of the three-dimensional part in a layer-by-layer manner by extruding a flowable part material. The part material is extruded through an extrusion tip or nozzle carried by a print head of the system and is deposited as a sequence on a substrate in an x-y plane. The extruded part material fuses to previously deposited part material and solidifies upon a drop in temperature. The position of the print head relative to the substrate is then incremented along a z-axis (perpendicular to the x-y plane), and the process is then repeated to form a three-dimensional part resembling the digital representation.

At present, many of the three-dimensional printing apparatuses transport a hot melt material to a melting nozzle by a feed material mechanism, and then heat and melt the hot melt material through the melting nozzle to apply the hot melt material layer by layer on a base, thereby forming the three-dimensional object. Due to material properties, different hot melt materials may have different melting points. If the temperature of the melting nozzle is too high or not properly controlled, the heated hot melt material may deteriorate or even burn. However, if the temperature of the melting nozzle is too low or not properly controlled, the hot melt material may not be melted completely, which results in jam or residue of the hot melt material in the feed material mechanism or the nozzle. Therefore, how to control the temperature of the melting nozzle in an ideal state is a concern of persons skilled in the art.

It would, therefore, be beneficial to provide an extruder or nozzle for use with an additive manufacturing device which could be used with a wide range of polymers, including filled and unfilled. It would also be beneficial to provide an extruder or nozzle which controls the temperature of the material until the material is deposited on a build plate. In addition, it would be beneficial to provide an extruder or nozzle which induces shear to control the viscosity of the material.

### SUMMARY OF THE INVENTION

An object of the invention is to provide a nozzle or extruder which can deliver with a wide range of materials to a build plate without degradation.

An object of the invention is to provide a nozzle or extruder which a heating mechanism which controls the temperature of the material until the material is deposited on a build plate.

An object of the invention is to provide a nozzle or extruder which induces shear in the material to control the viscosity of material.

An embodiment is directed to an extruder for use in an additive manufacturing process. The extruder includes a housing with a nozzle provided at one end thereof. A material feed channel extends through the extruder to the nozzle. A heating element is provided proximate the housing and extends about the entire circumference of the housing. The heating element provides even and controlled heating across the entire extruder.

An embodiment is directed to an extruder for use in an additive manufacturing process. The extruder includes an inner housing and an outer housing. A material feed channel extends through the extruder. The material feed channel is positioned between the inner housing and the outer housing. The inner housing is mounted to allow the inner housing to rotate relative to the outer housing and the outer housing is mounted to allow the outer housing to rotate relative to the inner housing. The rotation of the inner housing and outer housing moves material through the material feed channel and introduces shear forces to the material to decrease the viscosity of the material.

An embodiment is directed to an extruder for use in an additive manufacturing process. The extruder includes an inner housing and an outer housing. First threads extend outward from the inner housing and second threads extend inward from the outer housing into a cavity of the outer housing. A material feed channel extends through the extruder and is positioned between the inner housing and the outer housing. The first threads and the second threads are interleaved and are spaced apart to form the material feed channel which extends radially from a center longitudinal axis of the extruder. The inner housing is mounted to allow the inner housing to rotate relative to the outer housing and the outer housing is mounted to allow the outer housing to rotate relative to the inner housing. The rotation of the inner housing and outer housing moves material through the material feed channel and introduces shear forces to the material to decrease the viscosity of the material. A heating element is provided proximate the outer housing. The heating element extends about the entire circumference of the outer housing, wherein the heating element provides even and controlled heating across the entire extruder.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative embodiment of a three-dimensional printing apparatus in which an extruder of the present invention can be used.

FIG. 2 is an enlarged perspective view of an illustrative embodiment of the extruder of the present invention.

FIG. 3 is an enlarged cross-sectional view of the extruder shown in FIG. 2, taken along line 3-3 of FIG. 2.

FIG. 4 is an enlarged cross-sectional view of the extruder shown in FIG. 2, taken along line 4-4 of FIG. 2.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

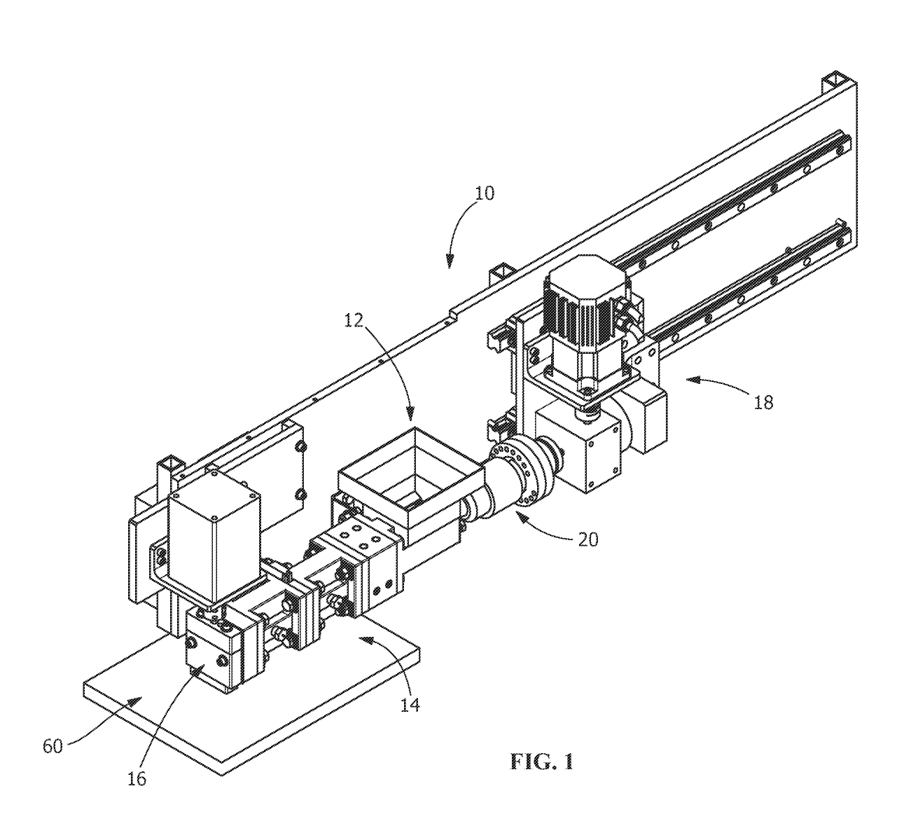

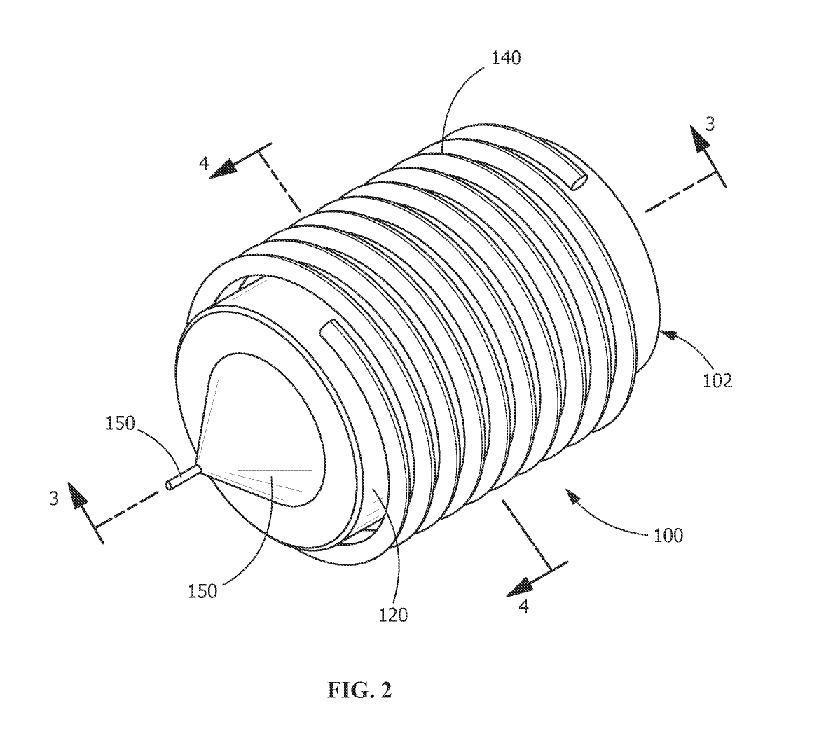

Referring to FIG. 1, an illustrative three-dimensional printing apparatus 10 is shown. The extruder 100 (FIG. 2) of the present invention may be used with such an apparatus. However, the extruder 100 may be used with other three-dimensional printing apparatus/processes or other additive manufacturing apparatus/processes. Such additive manufacturing processes may include, but are not limited to, fused filament fabrication (FFF), fused deposition modeling (FDM), melted extrusion modeling, stereolithography (SLA), laminated object manufacturing (LOM), direct laser melting (DLM), selective laser melting (SLM) and electron beam melting (EBM).

The illustrative apparatus 10 is more fully disclosed in U.S. patent application Ser. No. 14/870,307, which is hereby incorporated by reference in its entirety. The apparatus 10 shown and described is shown for illustrative purposes only and is not meant to limit the applicability of the extruder 100 to other apparatus or other processes. The apparatus 10 includes a material receiving area or hopper 12, a plasticizer 14 and a discharge pump 16. In general, the three-dimensional printing apparatus 10 is configured to allow a wide range of materials to be used to produce a three-dimensional object, such as, but not limited to, polymers, which may include, but are not limited to, filled polymers in the form of pellets or other ground forms. The materials can also include regrind. Any number of other materials can be used provided they are plasticizable by the device and are dischargeable by the discharge pump 16.

As shown in FIG. 1, the three-dimensional printing apparatus 10 includes a motor and drive train transmission 18, a chuck 20, an auger (not shown), the hopper 12, the plasticizer 14 and the discharge pump 16 which includes the extruder 100.

In the embodiment shown, the motor and drive train transmission 18 are mounted on rails to allow the motor and drive train transmission 18 to be moved along the longitudinal axis of the apparatus 10 to compensate for the different length of augers which may be used. However, mounting mechanisms can be used.

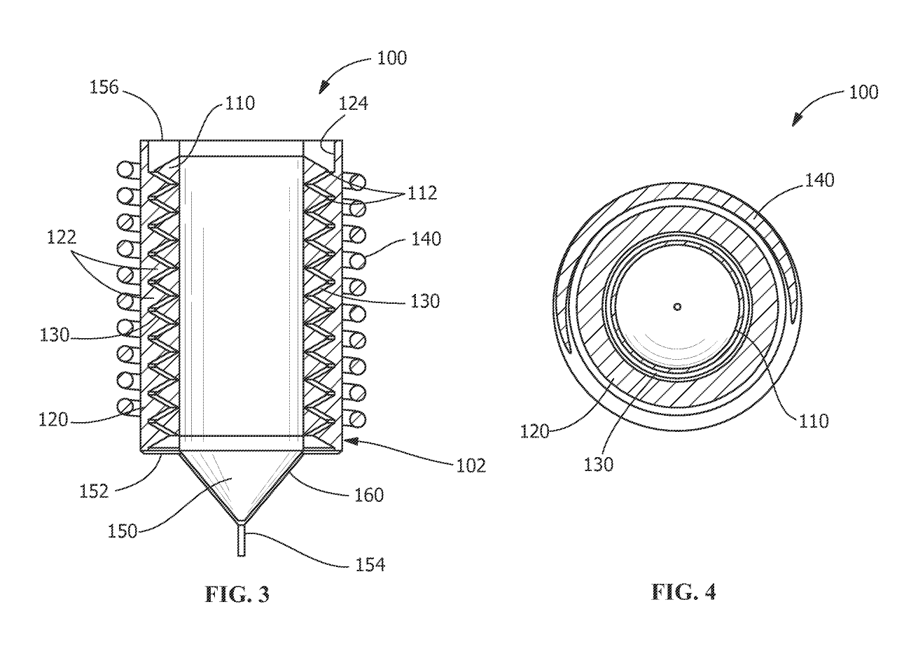

As shown in FIGS. 2 through 4, the extruder 100 has a housing assembly 102 and a heating element 140. The housing assembly 102 having an inner housing 110, an outer housing 120. First projections or first threads 112 extend outward from the inner housing 110. In the embodiment shown, the inner housing 110 has a generally cylindrical configuration with a consistent diameter and the threads 112 are equally spaced. However, other configurations of the inner housing 110 can be used without departing from the scope of the invention. For example, in order to better control shear of various material, the diameter of the inner housing 110 may be varied and/or the spacing or pitch of the threads 112 may be varied.

Second projections or second threads 122 extend inward from the outer housing 120 into a cavity 124. The cavity 124 has a generally cylindrical configuration with a consistent diameter, and the threads 122 are equally spaced. However, other configurations of the outer housing 120 and cavity 124 can be used without departing from the scope of the invention. For example, in order to better control shear of various material, the diameter of the cavity 124 may be varied and/or the spacing or pitch of the threads 122 may be varied.

The first threads 112 and second threads 122 are interleaved and are spaced apart to form a material feed channel 130 which extends parallel to the longitudinal axis of the extruder 100. The width of the material feed channel 130 is maintained during operation. However, the width of the material feed channel 130 may vary according to the material used for the additive manufacturing process. In the embodiment shown, the material feed channel 130 has a consistent width over the entire length. However, depending upon the configuration of the inner housing 110, first threads 112, outer housing 120, second threads 122 and/or cavity 124, the width of the material feed channel 130 may vary.

The inner housing 110 is mounted to allow the inner housing 110 to rotate relative to the outer housing 120. The inner housing 110 may rotate in either a clockwise or counterclockwise direction. The outer housing 120 is mounted to allow the outer housing 120 to rotate relative to the inner housing 110. The outer housing 120 may rotate in either a clockwise or counterclockwise direction. In the illustrative embodiment shown, the inner housing 110 and the outer housing 120 rotate in opposite directions.

The rotation of the inner housing 110 and outer housing 120 moves the material through the extruder 100 and introduces shear forces to the material to facilitate the melt of the material. Many materials do not flow well under controlled temperatures unless shear is introduced into the material. Without shear, excessive temperatures would be required to melt the material. These excessive temperatures would degrade the material.

The heating element 140 is provided to properly melt the material as the material is moved through the extruder 100. In the embodiment shown, the heating element 140 is an induction coil, but other heating elements can be used. In various embodiments, temperature sensors (not shown) may be provided to allow the temperature of the extruder and the material to be properly monitored and controlled.

A tapered section 150 is provided proximate an end of the extruder 100. The tapered section 150 converges to a nozzle 154 through which the material is dispensed to a build plate 60 (FIG. 1). Material feed channel 160 aligns with material feed channel 130 and extends to the nozzle 154 to deliver the material from the material feed channel 130 to the nozzle 154.

When in use, material which deposited in the hopper or material receiving area 12 is transported to the extruder 100. The material is maintained under pressure as it is delivered to the extruder 100. The extruder 100 controls the flow of material independent of pressure.

As previously described, the extruder 100 has an inner housing 110 with threads 112 which is rotatably driven at a desired speed by an appropriate sized motor or the like. The extruder 100 also has an outer housing 120 with threads 122 which is rotatably driven at a desired speed by an appropriate sized motor or the like. The relative rotation of the threads 112 of the inner housing 110 and the threads 122 of the outer housing 120 contributes to the control of the flow of the material through the extruder 100 from an end 156 which is attached to the discharge pump 16 to the nozzle 154. The relative movement of the inner housing 110 and the other housing 120 creates the volume and flow rates desired. In order to provide the pressure, volume and flow rates desired, the tolerances between the threads 112 and the thread 122 must be tightly controlled. For example, tolerances may be controlled to within 0.0002 of an inch.

In alternate illustrative embodiments, the threads 112, 122 which are spaced further from the nozzle 154 may be spaced apart from each other further then the threads 112, 122 which are spaced closer to nozzle 154. In one illustrative embodiment the threads 112, 122 which are spaced further from the nozzle 154 are spaced apart by 0.05 inches while the threads which are spaced closer to nozzle 154 are spaced apart by 0.04 inches. However, other spacing may be used without departing from the scope of the invention. For example, in order to better control the pressure, volume and flow rate of various material, the diameter of the inner housing 110 and the cavity 124 of the outer housing 120 may be varied and/or the spacing or pitch of the threads 112, 122 may be varied.

As previously stated, the rotation of the inner housing 110 relative to the outer housing 120 causing a portion of the material to move in one direction and another portion of the material to move in the opposite direction, thereby introducing shear forces to the material. The use of shear forces allows the material to be melted at lower temperatures, thereby conserving energy and preventing the degradation of the material due to excessive heating. Without shear forces, excessive temperatures may be required to melt the various materials, which could result in the degradation of the material.

As the viscosity of the material is inversely proportional to shear rate i.e. viscosity decreases with increasing shear rate, the viscosity of the material can be controlled by controlling the relative rotation of the inner housing 110 relative to the outer housing 120. Consequently, the relative rotational speeds of the inner housing 110 relative to the outer housing 120 can be used to control the viscosity of the material. The relative rotational speeds of the inner housing 110 relative to the outer housing 120 can be varied according the material used.

The heating element 140 is provided proximate the outer housing 120 and extends about the entire circumference of the outer housing 120. The heating element 140 extends from proximate a first end 156 of the outer housing 120 to proximate a second end 152 of the outer housing 120, thereby surrounding the outer housing 120 to provide even and controlled heating to the extruder 100. In the embodiment shown, the heating element 140 is an induction coil which heats the material to be extruded. The amount of current supplied to the induction coil will control the temperature. The current will be induced both in the inner housing 110, the outer housing 120 and the materials (if the material is ferrite). Even if the material is not ferrite, the heat will be transferred to the material from the inner housing 110 and the outer housing 120 to ultimately heat and melt the material. This provides even and controlled heating across the entire extruder 100. The temperature of the heating element 140 can be varied according the material used.

The extruder 100 disclosed herein can be used with a wide range of polymers, including filled and unfilled. As the material is maintained in shear during the extruding processing, the materials can be used without the need for excessive heating and without degradation to the materials.

Advantages of the extruder 100 include, but are not limited to: i) the ability to extrude highly viscous materials without degradation due to high extrusion temperatures; ii) control over viscosity of material as the rotation of the inner housing 110 relative to the outer housing 120 can be properly and precisely controlled; iii) the use of the heating element 140 and induced heating allows many materials to be used, including, but not limited to, metals and metal composites, in the additive manufacturing process; iv) the heating element 140 and the heating cycles can turned on and off quickly, as no start up time is required to preheat the heating element 140, allowing for better temperature control; v) heating element 140 and the induction heating allows for fast heating cycles and accurate heating patterns; vi) the use of the heating element 140 provides consistent heating with high thermal efficiency; and vii) all types of material, whether metallic or non-metallic can be extruded.

While the invention has been described with reference to a preferred embodiment, it will be understood by those skilled in the art that various changes may be made and equivalents may be substituted for elements thereof without departing from the spirit and scope of the invention of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An extruder for use in an additive manufacturing process, the extruder comprising:
a housing assembly having a nozzle provided at one end thereof;
a material feed channel which extends through the extruder to the nozzle;
a heating element provided proximate the housing, the heating element extending about the circumference of the housing;
wherein the heating element provides controlled heating across the extruder.

2. The extruder as recited in claim 1, wherein the heating element extends from proximate a first end of the extruder to proximate a second end of the extruder.

3. The extruder as recited in claim 1, wherein the heating element is an induction coil which heats the material to be extruded.

4. The extruder as recited in claim 3, wherein the induction coil induces current in the housing.

5. The extruder as recited in claim 1, wherein the housing has an inner housing and outer housing with the material feed channel positioned therebetween.

6. The extruder as recited in claim 5, wherein first threads extend outward from the inner housing.

7. The extruder as recited in claim 6, wherein second threads extend inward from the outer housing into a cavity of the outer housing.

8. The extruder as recited in claim 7, wherein the inner housing has a generally cylindrical configuration with a consistent diameter and the first threads are equally spaced.

9. The extruder as recited in claim 8, wherein the cavity has a generally cylindrical configuration with a consistent diameter and the second threads are equally spaced.

10. The extruder as recited in claim 7, wherein the first threads and the second threads are interleaved and are spaced apart to form the material feed channel which extends radially from a center longitudinal axis of the extruder.

11. The extruder as recited in claim 5, wherein the inner housing is mounted to allow the inner housing to rotate relative to the outer housing and the outer housing is mounted to allow the outer housing to rotate relative to the inner housing, wherein the rotation of the inner housing and outer housing moves material through the material feed channel and introduces shear forces to the material to facilitate the melt of the material.

12. An extruder for use in an additive manufacturing process, the extruder comprising:
an inner housing and an outer housing;
a material feed channel which extends through the extruder, the material feed channel positioned between the inner housing and the outer housing; and
the inner housing is mounted to allow the inner housing to rotate relative to the outer housing and the outer housing is mounted to allow the outer housing to rotate relative to the inner housing, wherein the rotation of the inner housing and outer housing moves material through the material feed channel and introduces shear forces to the material to decrease the viscosity of the material.

13. The extruder as recited in claim 12, wherein first threads extend outward from the inner housing and second threads extend inward from the outer housing into a cavity of the outer housing.

14. The extruder as recited in claim 13, wherein the inner housing has a generally cylindrical configuration with a consistent diameter and the first threads are equally spaced, and the cavity has a generally cylindrical configuration with a consistent diameter and the second threads are equally spaced.

15. The extruder as recited in claim 13, wherein the first threads and the second threads are interleaved and are spaced apart to form the material feed channel which extends radially from a center longitudinal axis of the extruder.

16. The extruder as recited in claim 13, wherein the first threads and second threads spaced further from a nozzle of the extruder are spaced apart from each other further then the first threads and second threads spaced closer to the nozzle.

17. The extruder as recited in claim 13, wherein a width of the material feed channel varies according to the material used for the additive manufacturing process.

18. The extruder as recited in claim 12, wherein a heating element is provided proximate the housing, the heating element extending about the entire circumference of the housing, wherein the heating element provides even and controlled heating across the entire extruder.

19. The extruder as recited in claim 16, wherein the heating element is an induction coil which heats the material to be extruded.

20. An extruder for use in an additive manufacturing process, the extruder comprising:
an inner housing and an outer housing, first threads extend outward from the inner housing and second threads extend inward from the outer housing into a cavity of the outer housing;
a material feed channel which extends through the extruder, the material feed channel positioned between the inner housing and the outer housing;
the first threads and the second threads are interleaved and are spaced apart to form the material feed channel which extends radially from a center longitudinal axis of the extruder;
the inner housing is mounted to allow the inner housing to rotate relative to the outer housing and the outer housing is mounted to allow the outer housing to rotate relative to the inner housing, wherein the rotation of the inner housing and outer housing moves material through the material feed channel and introduces shear forces to the material to decrease the viscosity of the material; and
a heating element provided proximate the outer housing, the heating element extending about the entire circumference of the outer housing, wherein the heating element provides even and controlled heating across the entire extruder.
